(19) United States
(12) Patent Application Publication
(10) Pub. No.: US 2012/0104189 A1
(43) Pub. Date: May 3, 2012

(54) MOTHER'S THIRD HAND SYSTEMS

(76) Inventors: Sandra Watson, Interlachen, FL (US); Billy J. Watson, Interlachen, FL (US)

(21) Appl. No.: 13/104,171

(22) Filed: May 10, 2011

Related U.S. Application Data
(60) Provisional application No. 61/408,693, filed on Nov. 1, 2010.

(51) Int. Cl. A47D 15/00; B23P 11/00

(52) U.S. Cl. 248/104; 248/103; 29/428

(57) ABSTRACT

A hands-free baby bottle holder for holding a baby bottle in various positions comfortable for feeding a baby comprising a sleeve which can be removably wrapped around a baby bottle and which secures to itself via at least one fastening device. Four rings are coupled to the sleeve. Two of the four rings are coupled to the top of the sleeve and the remaining two of the four rings are coupled to the bottom of the sleeve. Four removable and adjustable cords are each connected to one of the four rings via a securing device situated at the first end of each of the four removable and adjustable cords. Each of the second ends of the four removable and adjustable cords is attached to clothing or around handle bars on strollers, car seats and the like via a clipping device so as to hold the bottle in a position comfortable for feeding a baby.

### CROSS-REFERENCE TO RELATED APPLICATION

The present application is related to and claims priority from prior provisional application Ser. No. 61/408,693, filed Nov. 1, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of baby bottle holders and more specifically relates to a hands-free baby bottle holder for holding a baby bottle in various positions comfortable for feeding a baby.

2. Description of the Related Art

Being a parent is not easy, particularly when it comes to the task of taking care of a baby. Especially when feeding the baby, parents and caregivers often wish they had an extra hand. The parent has to hold the baby, hold the bottle in a position that is comfortable for the baby and often has to simultaneously complete other tasks, such as answering a phone, opening a door, etc. In order to complete these various tasks, the parent usually has to interrupt feeding the baby.

Further, many occasions arise when a parent is not able to hold the bottle at all, such as when the baby is in a stroller or in a child car seat in the back of a car. The parent needs to constantly lean over and take care that the baby is still holding the bottle in the proper position and does not drop the bottle. This makes travelling or shopping with a baby an arduous task and may cause stress and aggravation.

Therefore a need exists for a baby bottle holder that enables the adult to perform various tasks, such as answering the telephone, while the baby in her/his arms is feeding. Further, a need exists for a baby bottle holder that can alternatively be attached to a stroller or child car seat and can be adjusted to a comfortable height and angle and which allows the baby to drink without requiring the parent to be actively involved.

Thus a need exists for a device which can be used to hold a bottle while a baby is being held in the parent's arms or alternatively while the baby is in a stroller or child car seat.

Various attempts have been made to solve the above-mentioned problems such as those found in U.S. Pat. Nos. 5,873,551, 4,718,623, 4,220,302, 6,978,918, 6,606,768, and 2006/0255214. This prior art is representative of baby bottle holders. None of the above inventions and patents, taken either singly or in combination, is seen to describe the invention as claimed.

Ideally, a baby bottle holder should allow the caregiver to partake in a second activity without interrupting the feeding of the baby, be easy to use, operate reliably and be manufactured at a modest expense. Thus, a need exists for a reliable Mother's Third Hand System to allow the caregiver to partake in a second activity while holding the baby or while transporting the baby without interrupting the feeding of the baby and to avoid the above-mentioned problems.

### BRIEF SUMMARY OF THE INVENTION

In view of the foregoing disadvantages inherent in the known baby bottle holder art, the present invention provides a novel Mother's Third Hand System. The general purpose of the present invention, which will be described subsequently in greater detail, is to provide a hands-free baby bottle holder for holding a baby bottle in various positions comfortable for feeding a baby.

The hands-free baby bottle holder for holding a baby bottle in various positions comfortable for feeding a baby preferably comprises the following components: a sleeve, a fastening device, two removable and adjustable cords, each with a securing device at one end and a clipping device at the other end, and four rings.

The sleeve may be removably wrapped around the baby bottle and secures to itself via a fastening device. The two removable and adjustable cords each have a first end and a second end. The cords are each equipped with a securing device at the first end and a clipping device at the second end. The four rings are coupled to the sleeve, whereby two of the four rings are coupled to the top of the sleeve and the remaining two rings are coupled to the bottom of the sleeve.

Each of the first ends of the two removable and adjustable cords is connected to one of the two rings coupled to the top of the sleeve via one of the securing devices and each of the second ends of the two cords is connected to the clothes of a user via one of the clipping devices. Alternatively, each of the second ends of the two cords may be connected to the two rings coupled to the bottom of the sleeve via the clipping devices so as to create two loops which may be used to hang the bottle from a variety of objects, such as a handle bar of a stroller. In yet another embodiment, the hands-free baby bottle holder may comprise four removable and adjustable cords which may be attached to handle bars on strollers, car seats, clothes, etc. via the clipping devices located at the ends of the four cords.

A kit is also described herein including at least one sleeve, at least one removable and adjustable cord, at least one securing device, at least one clipping device, and at least one ring. The kit may include a set of user instructions.

In accordance with the embodiments of the present invention a preferred method of using a hands-free baby bottle holder for holding a baby bottle in various positions comfortable for feeding a baby is also disclosed herein preferably comprising the steps of: wrapping a sleeve around a baby bottle, securing the sleeve to itself via a fastening device, connecting two first ends of two removable and adjustable nylon cords via two round carabiner hooks to two rings, which are coupled to the top of the sleeve, and attaching two second ends of the removable and adjustable nylon cords to clothing via two metal suspender clips so as to hold the bottle in a position comfortable for feeding an infant.

The present invention holds significant improvements and serves as a Mother's Third Hand System. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Mother's Third Hand Systems, constructed and operative according to the teachings of the present invention.

FIG. 1 shows a perspective view illustrating a hands-free baby bottle holder next to a bottle according to an embodiment of the present invention.

FIG. 2 is a perspective view illustrating the hands-free baby bottle holder wrapped around a bottle according to an embodiment of the present invention of FIG. 1.

FIG. 3 is a perspective view illustrating the hands-free baby bottle holder attached to the clothes of a user according to an embodiment of the present invention of FIGS. 1-2.

FIG. 4 is a perspective view illustrating the hands-free baby bottle holder strapped to the handle bar of a stroller according to an embodiment of the present invention of FIGS. 1-3.

FIG. 5 is a flowchart illustrating a method of use according to an embodiment of the present invention of FIGS. 1 and 2.

The various embodiments of the present invention will hereinafter be described in conjunction with the appended drawings, wherein like designations denote like elements.

### DETAILED DESCRIPTION

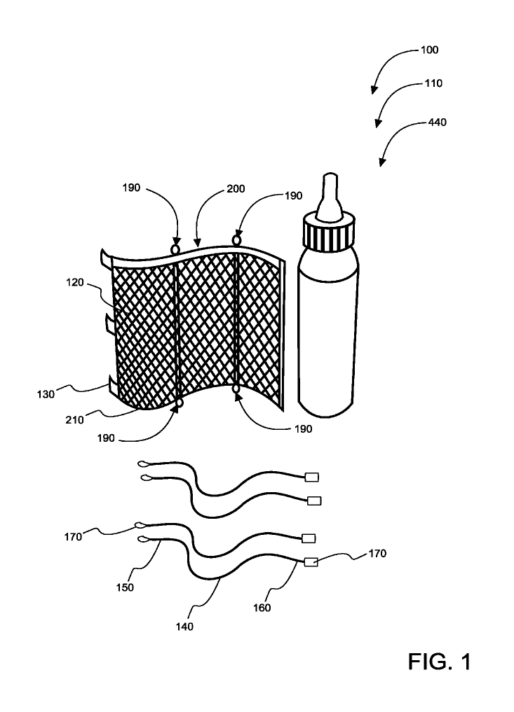

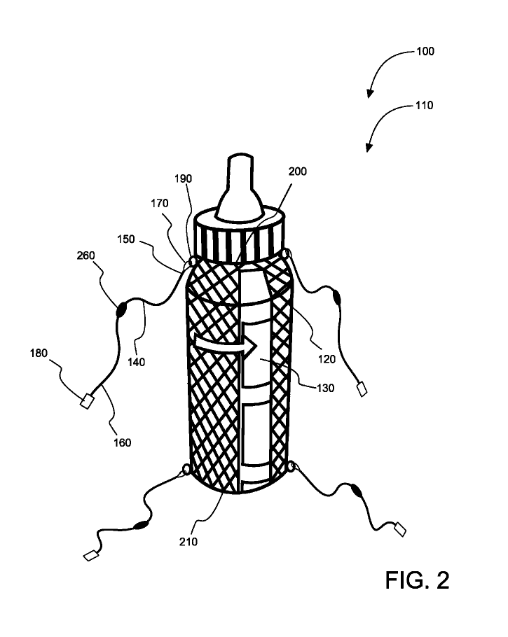

As discussed above, embodiments of the present invention relate to a baby bottle holder device and more particularly to a hands-free baby bottle holder for holding a baby bottle in various positions comfortable for feeding a baby. Referring to the drawings by numerals of reference there are shown in FIGS. 1 and 2, perspective views illustrating a hands-free baby bottle holder 110 according to an embodiment of the present invention.

Mother's Third Hand Systems 100 as disclosed herein may preferably comprise sleeve 120 which can be removably wrapped around a baby bottle and which secures to itself via at least one fastening device 130, four rings 190 which are coupled to sleeve 120, and four removable and adjustable cords 140 comprising four securing devices 170 and four clipping devices 180.

Sleeve 120 within this particular embodiment preferably comprises small mesh cotton netting. However, sleeve 120 may comprise any kind of netting comprising any durable, washable and suitable material, such as nylon or polyester. Alternatively, sleeve 120 may comprise a thin sheet of flexible, stretchable and wrappable non-slip fabric, such as fabrics comprising combinations of cotton and spandex or cotton and lycra. Sleeve 120 may be designed to wrap around a bottle and may measure approximately 8 inches in length×5½ inches in width. However, sleeve 120 may be available in a variety of sizes and shapes catered to fit various bottles currently available on the market. Different colors may be available to suit user's 240 preferences.

Sleeve 120 may be wrapped around a baby bottle and may preferably secure to itself via three fastening devices 130. Fastening devices 130 preferably comprise three hook pads (Velcro) sewn to one side of sleeve 120 and three mating loop pads (Velcro) sewn to the opposing side of sleeve 120. After wrapping sleeve 120 around the bottle, the hook and loop pads (Velcro) may be temporarily secured to one another so as to secure sleeve 120 around the baby bottle. Alternatively, three hook and loop pads may be sewn to one side of sleeve 120 and a mating hook and loop strap which goes over the entire length of the side may be sewn to the opposing side of sleeve 120. However, fastening device 130 may comprise any suitable fastening means which may connect the two opposing ends of sleeve 120, such as snap fasteners or buttons.

Four rings 190 are coupled to sleeve 120. Two of the four rings 190 are coupled to the top 200 of sleeve 120, located near the bottle neck. Rings 190 are attached to sleeve 120, separated by a distance of approx 1/3 of the circumference of the bottle so as to provide stability. The remaining two rings 190 are coupled to the bottom 210 of sleeve 120, located near the base of the bottle. Rings 190 are attached to the sleeve 120, separated by a distance of approx ⅓ of the circumference of the bottle so as to provide stability. The four rings 190 preferably comprise stainless steel and each have a diameter of approximately ¼ inch.

Mother's Third Hand Systems 100 comprises four removable and adjustable cords 140, each with a first end 150 and a second end 160. Each of the four rings 190 is connected to one of the four removable and adjustable cords 140 via securing device 170 situated at the first end 150 of each of the four removable and adjustable cords 140. Removable and adjustable cords 140 preferable comprise thin nylon cords. However, removable and adjustable cords 140 may comprise any durable material, such as polyester or polypropylene.

Removable and adjustable cords 140 may each comprise a length adjuster 260 such as a slide lock, strap adjuster or cam buckle. Length adjuster 260 may be used to lengthen or shorten removable and adjustable cord 140.

The four removable and adjustable cords 140 each comprise a first end 150 and a second end 160. The four removable and adjustable cords 140 are each equipped with a securing device 170 at the first end 150. Each of the four rings 190 which are coupled to sleeve 120 is connected to one of the four removable and adjustable cords 140 via securing device 170. Securing device 170 preferably comprises a round carabiner hook. The four removable and adjustable cords 140 further are each equipped with a clipping device 180 at the second end 160. Clipping device 180 preferably comprises a metal suspender clip.

Each of the second ends 160 of the four removable and adjustable cords 140 may be attached to clothes 220, to handle bars 230 on strollers, or car seats and the like via clipping device 180, so as to hold the bottle in a position comfortable for feeding a baby. Since there are four removable and adjustable cords 140 attached to sleeve 120, user 240 may attach each removable and adjustable cord 140 independently and adjust the length of each removable and adjustable cord 140 individually until a desired position and angle of the bottle is achieved.

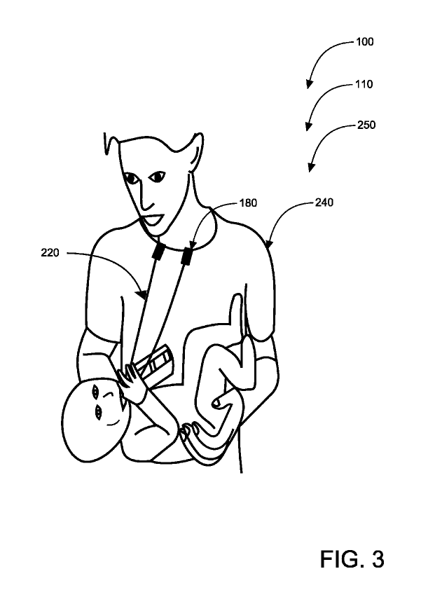

Referring now to FIG. 3, a perspective view illustrating the hands-free baby bottle holder 110 attached to the clothes 220 of a user 240 according to an embodiment of the present invention of FIGS. 1-2.

FIG. 3 illustrates an alternative embodiment of the hands-free baby bottle holder 110 for holding a baby bottle in various positions. The hands-free baby bottle holder 110 may comprise two removable and adjustable cords 140, each with a first end 150 and a second end 160, and each equipped with a securing device 170 at the first end 150 and a clipping device 180 at the second end 160.

Each of the first ends 150 is connected to one of the two rings 190 coupled to the top 200 of sleeve 120 via securing device 170 and each of the second ends 160 is connected to the clothes 220 of a user 240 via clipping device 180. This allows user 240 who is holding a baby to partake in a second activity without interrupting the feeding of the baby thereby creating in-use condition 250. The bottle is conveniently located within reach of the baby's grasp. The caregiver may answer a phone, take a drink, or complete any other task that may be required of them without being afraid that the baby stops drinking or that the bottle drops to the floor.

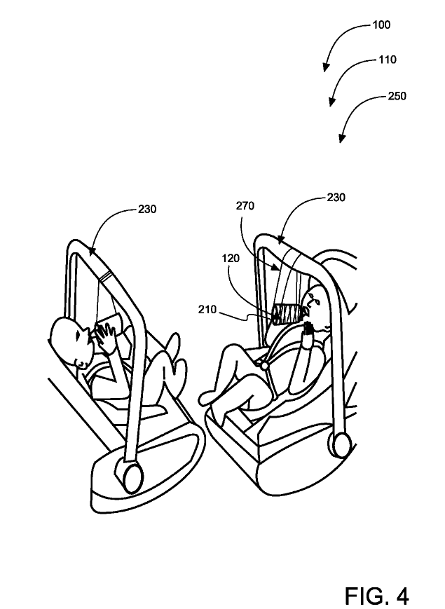

Referring now to FIG. 4, a perspective view illustrating the hands-free baby bottle holder 110 attached to a handle bar 230 of a stroller according to an embodiment of the present invention of FIGS. 1-3.

FIG. 4 illustrates an alternative embodiment of the hands-free baby bottle holder 110 for holding a baby bottle in various positions. The hands-free baby bottle holder 110 comprises two removable and adjustable cords 140, each with a first end 150 and a second end 160, and each equipped with securing device 170 at the first end 150 and clipping device 180 at the second end 160. Each of the first ends 150 is connected to one of the two rings 190 coupled to the top 200 of sleeve 120 via securing device 170 and each of the second ends 160 is connected to one of the two rings 190 coupled to the bottom 210 of sleeve 120 via the clipping device 180.

By securing removable and adjustable cords 140 to two rings 190 coupled to the top 200 of sleeve 120 and two rings 190 coupled to the bottom 210 of sleeve 120, loop 270 is formed. This way user 240 may first attach the removable and adjustable cords 140 via the securing devices 170 to two rings 190 coupled to the top 200 of sleeve 120, hang the two removable and adjustable cords 140 over a handle bar 230 of a stroller or child car seat and then clip clipping devices 180 to the two rings 190 coupled to the bottom 210 of sleeve 120 so as to hang the bottle from the handle bar 230 of a stroller or child car seat and to create in-use condition 250.

This way, another convenient method of hands-free bottle feeding is offered. If user 240 is not able to hold the bottle and feed the baby, such as when the baby is in a stroller or in a child car seat in the rear seat of a car, user 240 may simply place the two removable and adjustable cords 140 over the handle bar 230 of the stroller or child car seat and adjust the removable and adjustable cords 140 to the desired length, thereby placing the bottle in front of the baby and within reach of the baby's grasp and creating in-use condition 250.

Alternatively, user may use one removable and adjustable cord 140. User 240 may first attach the removable and adjustable cord 140 via the securing device 170 to ring 190 coupled to the top 200 of sleeve 120, wrap the removable and adjustable cord 140 around a handle bar 230 of a stroller or child car seat and then clip clipping device 180 to the ring 190 coupled to the bottom 210 of sleeve 120.

Mother's Third Hand Systems 100 may be sold as kit 440 comprising the following parts: at least one sleeve 120, at least one removable and adjustable cord 140, at least one securing device 170, at least one clipping device 180, at least one ring 190 and at least one set of user instructions.

Mother's Third Hand Systems 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

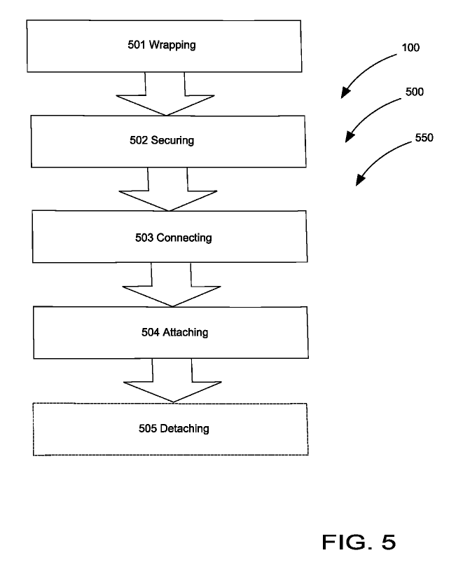

Referring now to FIG. 5, a flowchart 500 illustrating a method of use 550 according to an embodiment of the present invention of FIGS. 1-2.

In accordance with the embodiments of the present invention a preferred method of use 550 is disclosed herein comprising the following steps: step one 501 wrapping a sleeve 120 around a baby bottle, step two 502 securing sleeve 120 to itself via fastening device 130, step three 503 connecting two first ends 150 of two removable and adjustable cords 140 via two round carabiner hooks to two rings 190 which are coupled to the top 200 of sleeve 120, step four 504 attaching two second ends 160 of removable and adjustable cords 140 to clothing via two metal suspender clips so as to hold the bottle in a position comfortable for feeding an infant, step five 505 detaching each of second ends 160 of removable and adjustable cords 140 from clothing.

It should be noted that step five 505 is an optional step and may not be implemented in all cases. Optional steps of method of use 550 are illustrated using dotted lines in FIG.5 so as to distinguish them from the other steps of method of use 550.

It should be noted that the steps described in the method of use 550 can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A hands-free baby bottle holder for holding a baby bottle in various positions comfortable for feeding a baby comprising:
a sleeve which can be removably wrapped around a baby bottle and which secures to itself via at least one fastening device;
four removable and adjustable cords, each with a first end and a second end, and each equipped with a securing device at said first end and a clipping device at said second end;
four rings;
wherein said four rings are coupled to said sleeve, and two of said four rings are coupled to the top of said sleeve and two of said four rings are coupled to the bottom of said sleeve;
wherein each of said four rings is connected to one of said four removable and adjustable cords via said securing device situated at said first end of each of said four removable and adjustable cords;
wherein each of said second ends of said four removable and adjustable cords is attached to clothing or around handle bars on strollers, car seats and the like via said clipping device so as to hold the bottle in a position comfortable for feeding.

2. The hands-free baby bottle holder for holding a baby bottle in various positions of claim 1 wherein said hands-free baby bottle holder comprises two of said removable and adjustable cords, each with said first end and said second end, and each equipped with said securing device at said first end and said clipping device at said second end and wherein each of said first ends is connected to one of said two rings coupled to the top of said sleeve via said securing device and each of said second ends is connected to the clothes of a user via said clipping device.

3. The hands-free baby bottle holder for holding a baby bottle in various positions of claim 1 for hanging said baby bottle from the handle bar of a stroller wherein said hands-free baby bottle holder comprises two of said removable and adjustable cords, each with said first end and said second end, and each equipped with said securing device at said first end and said clipping device at said second end and wherein each of said first ends is connected to one of said two rings coupled to the top of said sleeve via said securing device and each of said second ends is connected to one of said two rings coupled to the bottom of said sleeve via said clipping device.

4. The hands-free baby bottle holder for holding a baby bottle in various positions of claim 1 wherein said sleeve comprises netting.

5. The hands-free baby bottle holder for holding a baby bottle in various positions of claim 4 wherein said netting comprises cotton.

6. The hands-free baby bottle holder for holding a baby bottle in various positions of claim 4 wherein said netting comprises nylon.

7. The hands-free baby bottle holder for holding a baby bottle in various positions of claim 1 wherein said sleeve comprises a thin sheet of wrappable fabric.

8. The hands-free baby bottle holder for holding a baby bottle in various positions of claim 7wherein said thin sheet of wrappable fabric is stretchable and non-slip.

9. The hands-free baby bottle holder for holding a baby bottle in various positions of claim 1 wherein said fastening device comprises three hook and loop fasteners.

10. The hands-free baby bottle holder for holding a baby bottle in various positions of claim 1 wherein said fastening device comprises three snap fasteners.

11. The hands-free baby bottle holder for holding a baby bottle in various positions of claim 1 wherein said four removable and adjustable cords comprise nylon.

12. The hands-free baby bottle holder for holding a baby bottle in various positions of claim 1 wherein said four removable and adjustable cords comprise a length adjuster.

13. The hands-free baby bottle holder for holding a baby bottle in various positions of claim 1 wherein said securing device comprises a round carabiner hook.

14. The hands-free baby bottle holder for holding a baby bottle in various positions of claim 1 wherein said clipping device comprises a metal suspender clip.

15. The hands-free baby bottle holder for holding a baby bottle in various positions of claim 1 wherein said four rings comprise stainless steel.

16. A hands-free baby bottle holder for holding a baby bottle in various positions comfortable for feeding a baby comprising:
a sleeve comprising cotton netting which can be removably wrapped around a baby bottle and which secures to itself via three hook and loop fasteners;
four removable and adjustable nylon cords, each with a first end and a second end, and each equipped with a securing device comprising a round carabiner hook at said first end and a clipping device comprising a metal suspender clip at said second end, and each comprising a length adjuster;
four stainless steel rings;
wherein two of said four stainless steel rings are coupled to the top of said sleeve and two of said four stainless steel rings are coupled to the bottom of said sleeve;
wherein each of said four stainless steel rings is connected to one of said four removable and adjustable nylon cords via said round carabiner hook situated at said first end of each of said four removable and adjustable nylon cords;
wherein each of said second ends of said four removable and adjustable nylon cords is attached to clothing or around handle bars on strollers, car seats and the like via said metal suspender clips so as to hold the bottle in a position comfortable for feeding a baby.

17. The hands-free baby bottle holder for holding a baby bottle in various positions comfortable for feeding a baby of claim 16 wherein said baby bottle holder further comprises a kit including said at least one sleeve, said at least one removable and adjustable cord, said at least one securing device, said at least one clipping device, said at least one ring and a set of user instructions.

18. A method of using a hands-free baby bottle holder for holding a baby bottle in various positions comfortable for feeding a baby comprising the steps of:
wrapping a sleeve around a baby bottle;
securing said sleeve to itself via a fastening device;
connecting two first ends of two removable and adjustable nylon cords via two round carabiner hooks to two rings, which are coupled to the top of said sleeve;
attaching two second ends of said removable and adjustable nylon cords to clothing via two metal suspender clips so as to hold the bottle in a position comfortable for feeding a baby.

19. The method of claim 18 further comprising the steps of:
detaching each of said second ends of said removable and adjustable nylon cords from clothing.
